(19) United States
(12) Patent Application Publication
(10) Pub. No.: US 2019/0042226 A1
(43) Pub. Date: Feb. 7, 2019

(54) METHOD AND SYSTEM FOR MULTI-LEVEL CONTENT PLATFORM

(71) Applicant: PARTICLE MEDIA, INC., Santa Clara, CA (US)

(72) Inventor: Zhaohui Zheng, Mountain View, CA (US)

(21) Appl. No.: 16/075,824

(22) PCT Filed: Feb. 7, 2016
(86) PCT No.: PCT/CN2016/073734

§ 371 Date: Aug. 6, 2018

(51) Int. Cl. G06F 8/60; G06F 17/30; G06F 3/0483

(52) U.S. Cl. CPC G06F 8/60; G06F 3/0483; G06F 17/30867

(57) ABSTRACT

The present teaching relates to a multi-level content platform. In one example, an interface corresponding to an application eco-space is presented to a user. The application eco-space comprises one or more applications. First information associated with the user is obtained via the interface. The first information characterizes interest of the user. At least one of the one or more applications is identified to be recommended to the user based on the first information. The at least one of the one or more applications is deployed within the application eco-space in a manner consistent with the interest of the user based on the first information.

### BACKGROUND

### 1. Technical Field

The present teaching relates to methods, systems, and programming for a content platform.

### 2. Discussion of Technical Background

On a mobile device, applications (apps) are usually downloaded and installed via an application (app) store, which is a type of digital distribution platform for computer software. Each app provides a specific set of functions for specific operating system(s). An app store (e.g., iOS App Store or Google Play) typically organizes the apps based on categories (e.g., games, books, health, sports, travel, etc.) for a user to browse, download, and install on a mobile device.

For example, FIG. 1 depicts a prior art app store. A user 102 uses a mobile device to interact with a plurality of apps 106, 108, 110 deployed in an operating system. The app store 106 acts as an interface for the user 102 to download and install apps 108-1, 108-2, . . . 108-i, . . . 108-n into the operating system. Other apps 110 may be pre-installed by the device maker and cannot be deployed via the app store 106. Nevertheless, once an app 108, 110 is deployed within the operating system 104, it becomes a standalone software for performing the specific set of functions as programmed, which is independent from the app store 106. In this example, when presenting the apps 108 available to the user 102, the app store 106 ranks the apps 108 based on various factors, e.g., popularity, recency, rating, etc.

However, data and content streams of different apps are oftentimes separate from each other and are not connected. In other words, each app becomes an “information silo.” Also, a user has to constantly activate and deactivate different apps in order to switch between those apps. Moreover, when a user migrates existing apps from one device to another device, the user needs to re-download and re-install each app. All these tedious and time-consuming operations affect user experience on deploying and using different apps on mobile devices. These and other drawbacks exist.

### SUMMARY

The present teaching relates to methods, systems and programming for a content platform. More specifically, the present teaching relates to methods, systems, and programming for a multi-level content platform.

In one example, a method, implemented on at least one computing device each of which has at least one processor, storage, and a communication platform connected to a network for deploying applications is presented. An interface corresponding to an application eco-space is presented to a user. The application eco-space comprises one or more applications. First information associated with the user is obtained via the interface. The first information characterizes interest of the user. At least one of the one or more applications is identified to be recommended to the user based on the first information. The at least one of the one or more applications is deployed within the application eco-space in a manner consistent with the interest of the user based on the first information.

In a different example, a system for deploying applications is presented. The system includes a user interest engine, a presentation module, and a deployment module. The user interest engine is configured for obtaining first information associated with a user. The first information characterizes interest of the user. The presentation module is configured for presenting an interface corresponding to an application eco-space to the user. The application eco-space comprises one or more applications. The presentation module is further configured for identifying at least one of the one or more applications to be recommended to the user based on the first information. The deployment module is configured for deploying the at least one of the one or more applications within the application eco-space in a manner consistent with the interest of the user based on the first information.

Other concepts relate to software for implementing the present teaching on deploying applications. A software product, in accord with this concept, includes at least one non-transitory, machine-readable medium and information carried by the medium. The information carried by the medium may be executable program code data, parameters in association with the executable program code, and/or information related to a user, a request, content, or information related to a social group, etc.

In one example, a non-transitory, machine-readable medium having information recorded thereon for deploying applications is presented. The recorded information, when read by the machine, causes the machine to perform a series of processes. An interface corresponding to an application eco-space is presented to a user. The application eco-space comprises one or more applications. First information associated with the user is obtained via the interface. The first information characterizes interest of the user. At least one of the one or more applications is identified to be recommended to the user based on the first information. The at least one of the one or more applications is deployed within the application eco-space in a manner consistent with the interest of the user based on the first information.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a prior art application store;

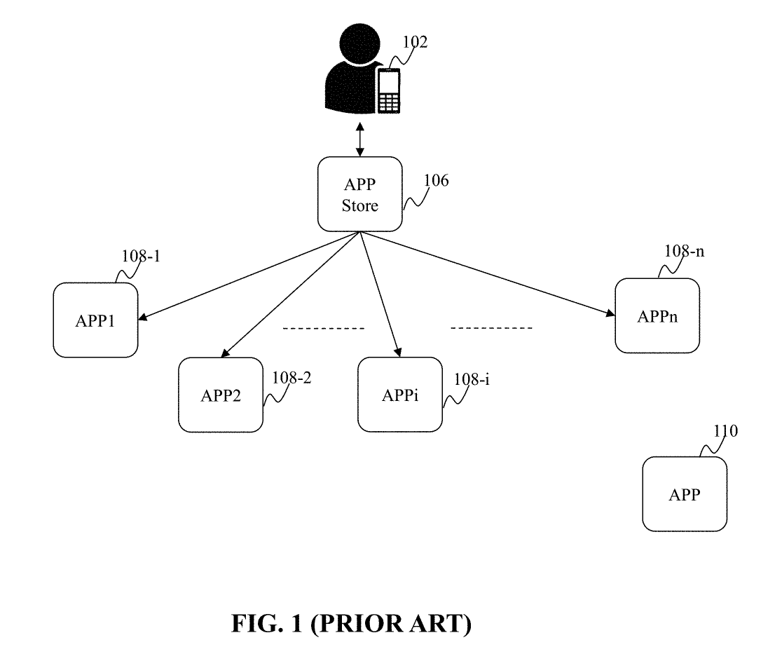

FIG. 2 depicts an interest-based personalized application eco-space, according to an embodiment of the present teaching;

FIG. 3 depicts an exemplary user interface of an application eco-space, according to an embodiment of the present teaching;

FIG. 4 depicts exemplary user interactions with an application eco-space, according to an embodiment of the present teaching;

FIG. 5 is a high level exemplary system diagram of an application eco-space, according to an embodiment of the present teaching;

FIG. 6 is a flowchart of an exemplary process performed by the application eco-space, according to an embodiment of the present teaching;

FIG. 7 illustrates an exemplary diagram of a user interest engine, according to an embodiment of the present teaching;

FIG. 8 is a flowchart of an exemplary process performed by the user interest engine, according to an embodiment of the present teaching;

FIG. 9 illustrates an exemplary diagram of an application presentation module, according to an embodiment of the present teaching;

FIG. 10 is a flowchart of an exemplary process performed by the application presentation module, according to an embodiment of the present teaching;

FIG. 11 illustrates an exemplary diagram of a content channel managing module, according to an embodiment of the present teaching;

FIG. 12 is a flowchart of an exemplary process performed by the content channel managing module, according to an embodiment of the present teaching;

FIGS. 13A and 13B depict exemplary user interfaces of application recommendation;

FIGS. 14A and 14B depict exemplary user interfaces of deployed applications and content channels associated with activated applications;

FIGS. 15A and 15B depict exemplary user interfaces of content channels associated with an activated application and content recommended from a content channel;

FIG. 16 depicts the architecture of a mobile device which can be used to implement a specialized system incorporating the present teaching; and

FIG. 17 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present teachings.

The present teaching describes methods, systems, and programming aspects of a multi-level content platform, realized as a specialized and networked system by utilizing one or more computing devices (e.g., mobile phone, personal computer, etc.) and network communications (wired or wireless). The multi-level content platform may be implemented as an interest-based personalized app eco-space in which a plurality of apps can be deployed based, at least in part, on individual user's interests. For each app in the app eco-space, the data and content stream may be organized by different content channels, each of which is directed to a specific interest of the user.

In one aspect of the present teaching, the entire interest-based personalized app eco-space may be driven by a user interest engine, which creates and updates a personal interest space for an individual user. Thus, each app in the app eco-space can fully utilize the user interest engine and/or the personal interest space to provide targeted content and optimize its functions in serving each individual user. Data and content streams of different apps in the app eco-space are connected and shared in the backend via the user interest engine and/or the personal interest space.

In another aspect of the present teaching, a user can easily switch between different apps deployed in the app eco-space without exiting the app eco-space. For example, tabs may be created and provided for each app on the same page of the interface of the app eco-space so that a user can switch between the apps in the app eco-space via the tabs. For better user experience, the look-and-feel of each app presented in the interface of the app eco-space may be uniform. To avoid mixing up content streams from different apps in the interface of the app eco-space, main content streams may be organized at the app level, and within each app, sub-content streams may be organized at the content channel level.

Additional novel features will be set forth in part in the description which follows, and in part will become apparent to those skilled in the art upon examination of the following and the accompanying drawings or may be learned by production or operation of the examples. The novel features of the present teaching may be realized and attained by practice or use of various aspects of the methodologies, instrumentalities, and combinations set forth in the detailed examples discussed below.

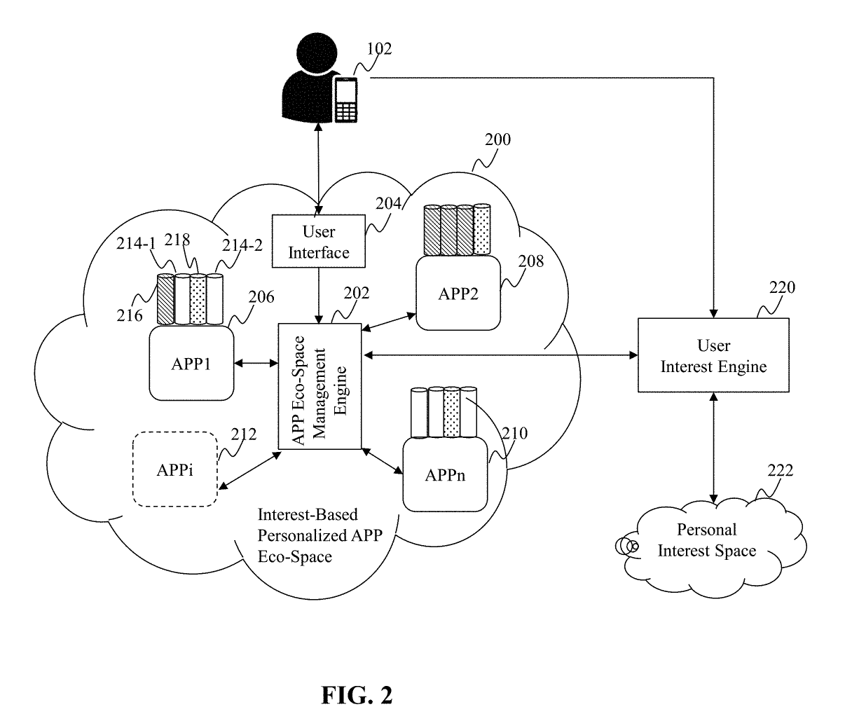

FIG. 2 depicts an interest-based personalized application eco-space, according to an embodiment of the present teaching. The interest-based personalized application eco-space 200 may be implemented as a “super app” deployed on an operating system, along with other apps deployed on the operating system 104, like the app store 106. The application eco-space 200 in this example includes an application eco-space management engine 202, a user interface 204, and a plurality of apps 206, 208, 210, 212. The application eco-space 200 is an open platform by which at least some of the apps 206, 208, 210, 212 may be created by third-party developers via application programming interfaces (APIs). Depending on the specific user 102, some of the apps 206, 208, 210 provided by the application eco-space 200 may be deployed within the application eco-space 200 so that the user 102 can activate them via the user interface 204; other apps 212 may not be deployed yet. Compared with other apps deployed directly on the operating system, each app 206, 208, 210 deployed within the application eco-space 200 may be considered as a sub-app within the application eco-space 200. As a result, the user 102 no longer needs to exit the application eco-space 200 in order to activate each deployed app 206, 208, 210.

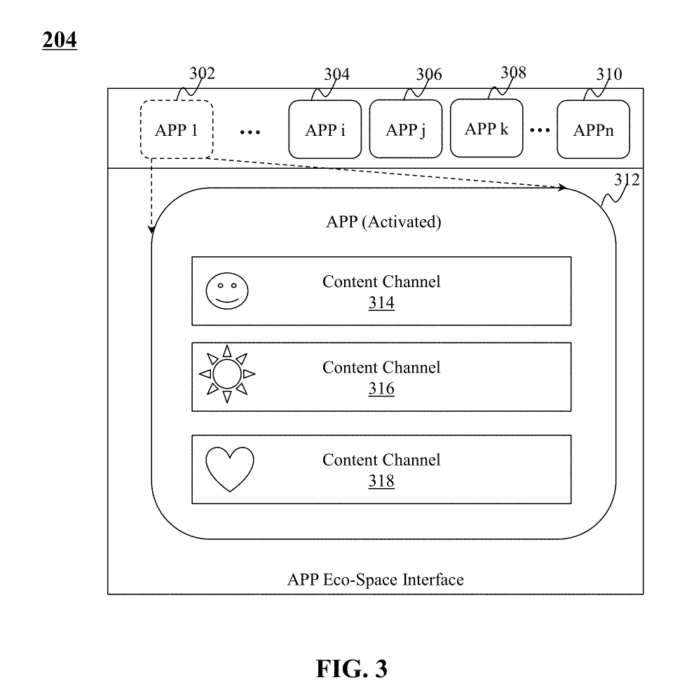

For example, tabs may be created and presented on the homepage of the user interface 204 so that the user 102 can switch between the deployed apps 206, 208, 210 via the tabs. Turning to FIG. 3, in an exemplary user interface 204, tabs 302, 304, 306, 308, 310 of the deployed apps are provided on the top portion of the homepage. Once a tab is clicked, e.g., 302, the corresponding app is activated, and its user interface 312 is presented on the main portion of the user interface 204. Tabs 304, 306, 308, 310 of other inactivated apps remain on the top portion of the homepage so that the user 102 can easily switch to another app by clicking the corresponding tab. Returning back to FIG. 2, in some embodiments, a link (e.g., a shortcut) may be created for each deployed app 206, 208, 210 and provided on the desktop of the operating system 104, similar to the links on the desktop for other apps deployed directly in the operating system, so that the user 102 can access the respective app within the application eco-space 200 directly via the desktop link. It is understood that as each app 206, 208, 210 is deployed within the application eco-space 200, accessing any deployed app 206, 208, 210 via the desktop link may cause the activation of the application eco-space 200 as well. In some embodiments, each deployed app 206, 208, 210 in the application eco-space 200 may send its own push notifications to the user 102.

In this example, the application eco-space 200 may be considered as the first level of a multi-level content platform above the operating system, parallel to other apps installed in the operating system; each deployed app 206, 208, 210 within the application eco-space 200 may be considered as the second level of the multi-level content platform, each of which has its own main data and content stream and may perform a set of functions as programmed. In this embodiment, each app 206, 208, 201, 212 provided by the application eco-space 200 is associated with a name, e.g., “Fashion,” “Phoenix Radio Station,” “Car Review,” etc. The names of the apps 206, 208, 210, 212 may become aliases of the application eco-space 200. That is, the application eco-space 200 may be associated with any names of the apps therein. For example, when the user 102 searches in the app store 106, any keyword related to the names of any apps provided by the application eco-space 200 may trigger the download of the application eco-space 200 via the app store 106. In other words, the application eco-space 200 can be identified and searched under the names of any apps provided therein.

In this embodiment, at least some of the apps 206, 208, 210 include a plurality of content channels from which the content associated with different interests are recommended. Taking APP1 206 for example, it includes multiple channels, each of which is associated with a specific user interest. Depending on the specific user 102, some channels 214-1, 214-2 may not be recommended to or selected by the user 102, some channels 216 may be recommended to the user 102 based on the user 102's interests, and some channels 218 may be directly searched and subscribed to by the user 102. When the user 102 activates the deployed APP 1 206 in the application eco-space 200, content may be recommended to the user 102 in accordance with each active content channel 216, 218. In this example, the content channels of each deployed app 206, 208, 210 may be considered as the third level of the multi-level content platform, each of which has its own sub-data and content stream. Turning now to FIG. 3, multiple content channels 314, 316, 318 are provided in the user interface 312 of the activated APP 1, and corresponding content is continuously recommended via the respective content channel 314, 316, 318. Each content channel may be associated with a specific interest of the user 102.

In this embodiment, as shown in FIG. 2, the apps 206, 208, 210, 212 provided by the app eco-space 200 are managed by the app eco-space management engine 202. As will be described below in detail, the app eco-space management engine 202 manages the development and update of apps via APIs, the recommendation and presentation of suitable apps to the user 102, the deployment of the apps within the app eco-space 200, the recommendation and presentation of suitable content channels of each deployed app to the user 102, and the recommendation of content via each subscribed channel to the user 102. The app eco-space management engine 202 in this example also coordinates with the user interest engine 220 to provide user interest information to each app for their interest-based personalized content and/or service. As an integrated system, user interactions with any of the deployed app 206, 208, 210 may cause the update and evolution of the app eco-space 200. The app eco-space management engine 202 may manage the update and evolution of the app eco-space 200. For example, when the user 102 continuously interacts with the deployed app 210, then another app 212 in the same category as the app 210 may be recommended to the user 102 even the user 102 has not chosen to deploy the app 212. The update and evolution of the app eco-space 200 may also occur at the content channel level across different apps. For example, if the user 102 constantly consumes content in the content channel 216 of the app 206, then similar content channels in other apps may also be recommended to the user 102 even the user 102 has not subscribed to them in other apps.

In this embodiment, the application eco-space 200 is backed-up by the user interest engine 220. As will be described below in detail, the user interest engine 220 creates and updates a personal interest space 222 for the user 102. The recommendation of apps and/or content channels may be performed based, at least in part, on the user interests from the personal interest space 222. In some embodiments, an API of the user interest engine 220 and/or the personal interest space 222 may be provided to the third-party developers so that they can utilize the user interests in their apps. For example, when a third-party developer feeds content to the user 102 via an app deployed within the application eco-space 200, the user 102's interest extracted from the personal interest space 222 may be used to filter and rank the content.

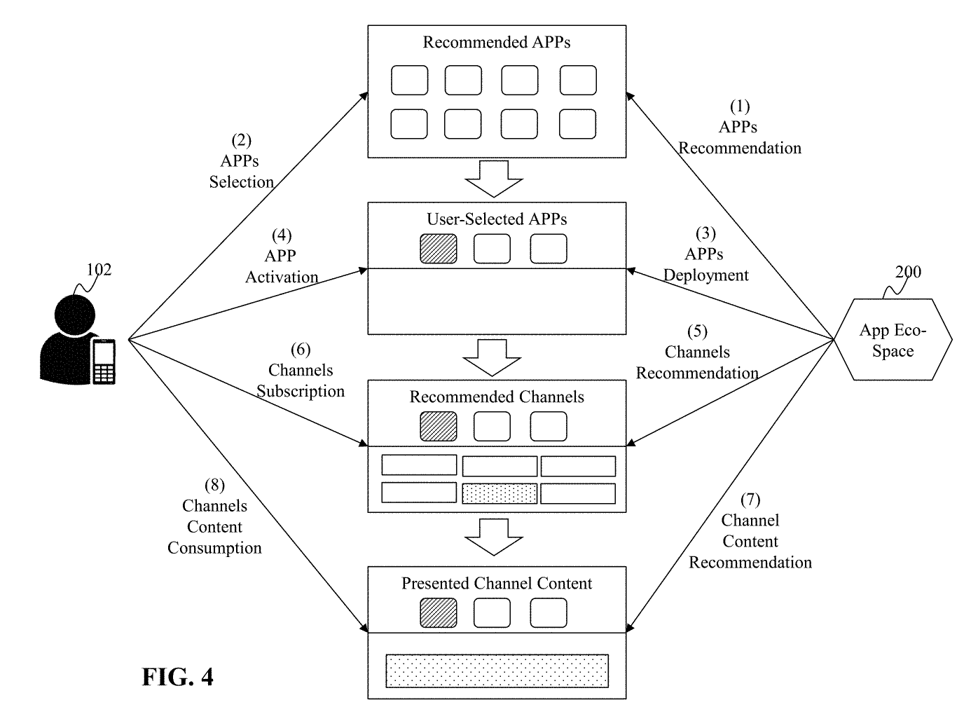

FIG. 4 depicts exemplary user interactions with an application eco-space, according to an embodiment of the present teaching. At step (1), the application eco-space 200 recommends a plurality of apps to the user 102. Some of the apps may be recommended based on the user 102's interests, and some of the apps may be recommended based on other factors, e.g., popularity, recency, user rating, etc., among the general user population. In this example, icons of each recommended app may be presented in the user interface of the application eco-space 200. At step (2), the user 102 may select one or more apps from the recommended apps. At step (3), the application eco-space 200 deploys the selected app(s) within the application eco-space 200. In this example, three apps are selected by the user 102 and are deployed within the application eco-space 200. The tabs of the three deployed apps are presented in the top portion of the homepage of the user interface. At step (4), the user 102 activates one of the deployed apps, e.g., by clicking the corresponding tab via the user interface. At step (5), for the activated app, the application eco-space 200 recommends a plurality of content channels to the user 102. Some of the content channels may be recommended based on the user 102's interests, and some of the content channels may be recommended based on other factors, e.g., popularity, recency, user rating, etc., among the general user population. At step (6), the user 102 selects and subscribes to one or more of the recommended content channels of the activated app. It is understood that in some embodiments, the user 102 can actively search and subscribe to content channels in addition to or without the application eco-space 200's recommendation. At step (7), the application eco-space 200 continuously recommends content related to the subscribed content channel when the corresponding app is activated in the application eco-space 200. At step (8), the user 102 consumes the recommended content, e.g., by reading, commenting, forwarding, or saving the content.

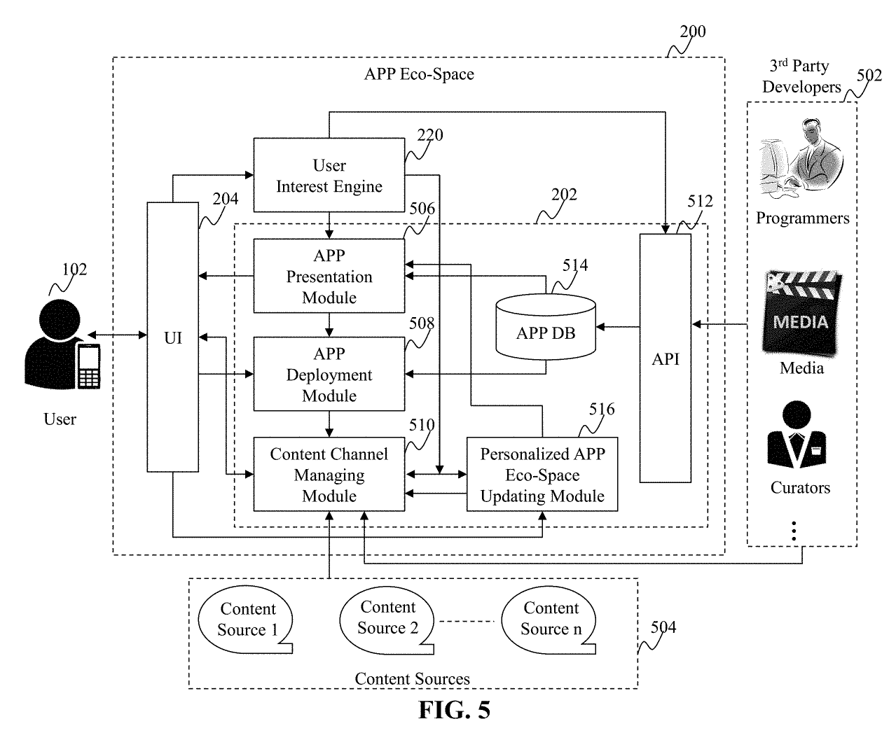

FIG. 5 is a high level exemplary system diagram of an application eco-space, according to an embodiment of the present teaching. The app eco-space 200 in this example interacts with the user 102, one or more third-party developers 502, and content sources 504. The third-party developer 502 may include programmers, media, curators, or any entities that create apps for the application eco-space 200. The content sources 504 may be vertical content sources, each of which is in a specific domain, such as sports, travel, automobile, weather, fashion, news, etc. The application eco-space 200 may include the user interface 204, the user interest engine 220, and the application eco-space management engine 202 having an application presentation module 506, an application deployment module 508, a content channel managing module 510, one or more APIs 512, an application database 514, and a personalize application eco-space updating module 516.

The user interface 204, as mentioned above, interacts with the user 102 to present apps, content channels, and content, and receives user input and any other information from the user 102. Each API 512 is an interface between the third-party developers 502 and the application eco-space 200 for creating and updating apps to be deployed within the application eco-space 200. In this embodiment, one of the them APIs 512 includes information about the user interest engine 220 such that the third-party developers 502 can incorporate functions and features that utilize the user interest engine 220 into their apps. In this embodiment, one of the APIs 512 includes information about the user interface specifications for the third-party developers 502 to comply with in order to ensure the uniform look-and-feel among different apps deployed within the application eco-space 200. The apps developed by the third-party developers 502 are stored in the application database 514. It is understood that in addition to the third-party apps, the application database 514 may also store apps developed by the same party who develops the application eco-space 200. As will be described below in detail, the user interest engine 220 receives information about the user 102 via the user interface 204 and creates and updates a personal interest space for the user 102. At least a portion of the information received by the user interest engine 220 characterizes interest of the user 102.

The application presentation module 506 in this example presents apps from the application database 514 to the user 102 via the user interface 204. Depending on the number of the apps stored in the application database 514, the application presentation module 506 may present some or all of the available apps. If only some the apps are presented to the user 102, these apps may be recommended by the application presentation module 506 based on the user 102's interests and/or other factors, e.g., popularity, recency, or user rating.

The application deployment module 508 in this example is configured to identify, from the presented apps, at least one app based on the information of the user 102 and to deploy the identified app(s) within the application eco-space 200. The user information may include the user 102's selection of app(s) to be deployed or any information related to the user 102's interests. For example, even if the user 102 does not explicitly select any app to be deployed, if the received information strongly indicates that the user 102 is interested in a particular app, then the application deployment module 508 may automatically deploy this app within the application eco-space 200. As mentioned above, when deploying the apps, the application deployment module 508 may generate a tab for each deployed app and present the tabs on the same page of the user interface 204 so that the user 102 can switch between the deployed apps via the tabs. The application deployment module 508 may also create a link for each deployed app on the desktop of the operating system so that the user 102 can access the deployed app in the application eco-space 200 via the links.

The content channel managing module 510 in this example is configured to determine content channels with respect to each deployed app based on the information associated with the user 102. In one example, content channels may be recommended to the user 102 in each deployed app based on the user 102's interests and/or other factors, e.g., popularity, recency, or user rating. The user 102 then may select and subscribe to one or more recommended content channels. In another example, the user 102 may actively search and subscribe to content channels in which the user 102 is interested. Once a content channel of a deployed app is subscribed to, the content channel managing module 510 may recommend content to the user 102 via the content channel within the app eco-space 200. The content may be fed from the corresponding content source 504, the third-party developer 502 who developed the app, and/or content from the personal interest space of the user interest engine 220.

As an integrated system, each user 102's interactions with any of the deployed app may cause the update and evolution of the app eco-space 200. In this embodiment, the personalized application eco-space updating module 516 manages the update and evolution of the app eco-space 200. The update may occur at the app level and/or the content channel level. In the app level, the personalized application eco-space updating module 516 may receive user information (e.g. the user 102's interactions with any of the deployed apps) via the user interface 204 and/or the user interest engine 220. Based on the received information, the personalized application eco-space updating module 516 may adjust any deployed apps or recommend un-deployed apps to the user 102 via the application presentation module 506. For example, when the user 102 continuously interacts with a deployed app, then another un-deployed app in the same category as the deployed app may be recommended to the user 102. The update and evolution of the app eco-space 200 may also occur at the content channel level across different apps. In the content channel level, the personalized application eco-space updating module 516 may receive user information (e.g. the user 102's interactions with any of the subscribed channels) via the user interface 204 and/or the user interest engine 220. Based on the received information, the personalized application eco-space updating module 516 may adjust any currently-subscribed channels of any deployed app or recommend new channels to the user 102. For example, if the user 102 constantly consumes content in a content channel of a deployed app, then similar content channels in other apps may also be recommended to the user 102.

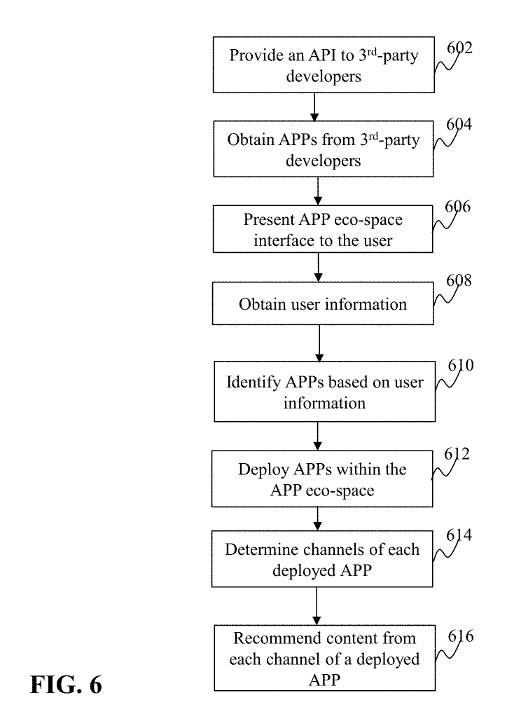

FIG. 6 is a flowchart of an exemplary process performed by the application eco-space, according to an embodiment of the present teaching. Starting at 602, an API is provided to third-party developers. The API may include information related to the user interest engine 220 and/or the user interface specifications. At 604, apps created by the third-party developers are obtained. The third-party apps may be stored in an application database. The third-party developers include, for example, programmers, media, and curators. At 606, an interface of the application eco-space deployed within an operating system is presented to a user. The application eco-space includes the apps stored in the application database. At 608, information related to the user is obtained. At least part of the information characterizes the user's interests. At 610, one or more apps are identified for the user from the apps available in the application database based on the user information. For example, at least one identified app matches with one of the user's interests. The user may also actively select recommended apps. At 612, the identified apps are deployed within the application eco-space in a manner consistent with the interest of the user based on the user's information. At 614, content channels are determined for each deployed app based on the user information. For example, at least one content channel matches with one of the user's interests. The user may also actively search and subscribe to content channels of interest. At 616, content is recommended from each content channel of the deployed app within the application eco-space.

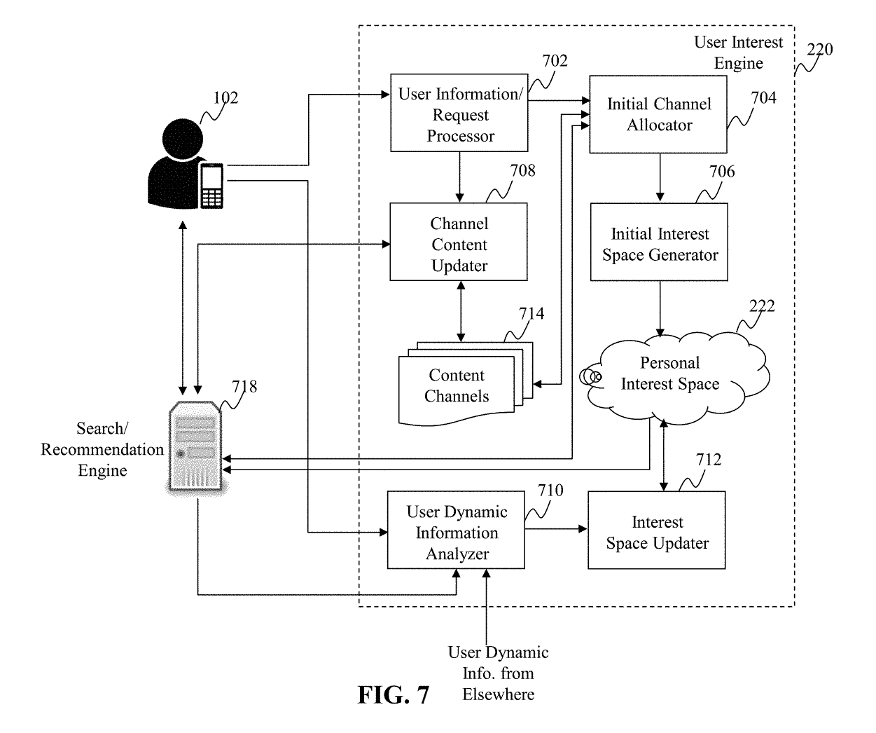

FIG. 7 illustrates an exemplary diagram of a user interest engine, according to an embodiment of the present teaching. In this example, the user interest engine 220 includes a user information/request processor 702, an initial channel allocator 704, an initial interest space generator 706, a channel content updater 708, content channels 714, a user dynamic information analyzer 710, an interest space updater 712, and the personal interest space 222.

The user information/request processor 702 in this example receives user information or a request from the user 102. The user information may include the user's demographic information, the user's personal information provided by the user 102 at registration or imported from another website, the user's input during initial setting when the user 102 logs in the application eco-space 200 for the first time, etc. For example, the user information may indicate that the user 102 is male, 35-years old, working as a software engineer, likes software and Internet during work time, and likes sports and games during the weekend. The request may be a subscription request from the user 102 to subscribe to a channel, a un-subscription request from the user 102 to unsubscribe from a channel, or a content update request to update content in a channel of the user' 102s personal interest space 222.

Based on the user information or the request, the initial channel allocator 704 may allocate channels for the user 102. The channel allocation may be based on the user 102's demographic information and initial setting when the user 102 logs in the application eco-space 200 for the first time. The channel allocation may also be based on a search query submitted by the user 102 to a search/recommendation engine 718 or to the user interest engine 220 directly. The search query may be for searching content items or channels. In one example, the initial channel allocator 704 may allocate an existing channel in the content channels 714 matching the user 102's query to the user 102. In another example, the initial channel allocator 704 may generate a new channel that is not in the content channels 714 and matches the user 102's query, and allocate the new channel to the user 102.

The initial interest space generator 706 in this example can generate the personal interest space 222 for the user 102 based on the channels allocated to the user 102 by the initial channel allocator 704. The personal interest space 222 may include information about the channels allocated to the user 102, and user information about the user 102. The personal interest space 222 is personal because it represents interest of the user 102 in terms of different channels. The channel content updater 708 in this example may update content of a channel, based on a request or a timer. As content in the Internet keeps changing and updating, the channel content updater 708 may obtain the most updated content items from the Internet and assign them into different channels according to their related topics. The channel content updater 708 may perform the updating periodically or upon a request from the user 102. In one embodiment, the channel content updater 708 may cooperate with the search/recommendation engine 718 to search for new information on the Internet for updating corresponding channels.

The user dynamic information analyzer 710 in this example may obtain the user 102's dynamic information. The dynamic information may include the user 102's interaction with the user interest engine 220 and/or the application eco-space 200. The dynamic information may also include the user 102's interaction with the search/recommendation engine 718. The dynamic information may further include the user 102's social connection with other users, from a social network. The dynamic information may also include the user 102's online behavior from other websites or apps. The user dynamic information analyzer 710 can analyze the dynamic information to generate user interest information associated with the user 102, and send the user interest information to the interest space updater 712. The interest space updater 712 in this example receives the user interest information and determines whether to update the personal interest space 222 of the user 102. For example, if the user interest information indicates a new interest of the user 102 that has not been included in any channel assigned to the user 102, the interest space updater 712 may determine to update the personal interest space 222 of the user 102 by adding a new channel to catch the new interest of the user 102. The interest space updater 712 may retrieve and update the personal interest space 222 of the user 102, and store it. Details of the user interest engine 220 are provided, for example, in PCT Patent Application No. PCT/CN2015/089288, filed Sep. 9, 2015, entitled “METHOD AND SYSTEM FOR PROVIDING ORGANIZED CONTENT,” which is incorporated herein by reference in its entirety.

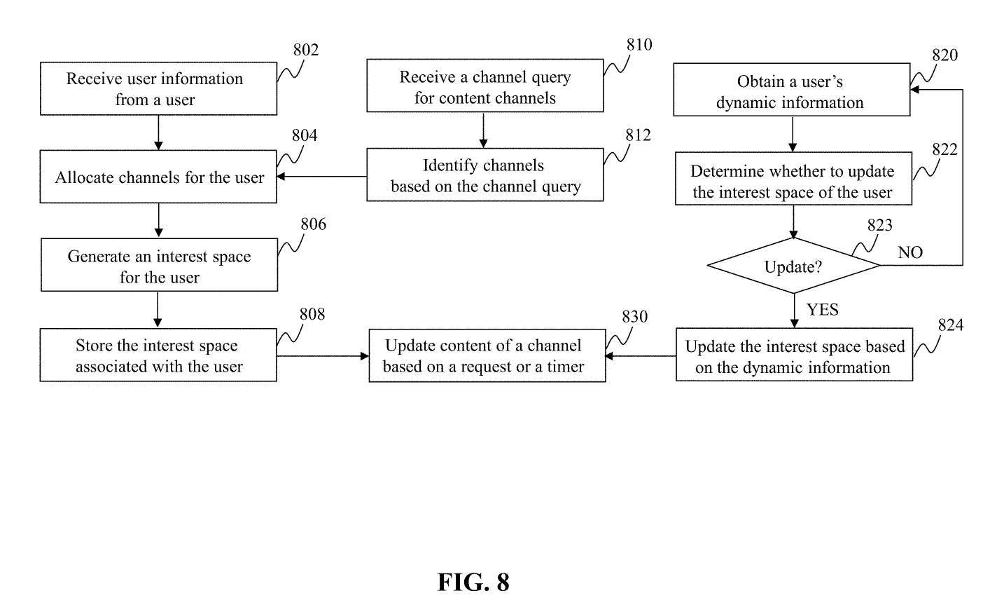

FIG. 8 is a flowchart of an exemplary process performed by the user interest engine, according to an embodiment of the present teaching. Starting at 802, user information from a user is received. Then, the process moves on to 804. In one embodiment, a channel query for content channels is received from the user at 810; one or more channels are identified based on the channel query at 812; and the process goes on to 804. At 804, channels are allocated to the user based on the user information and/or the channel query. A personal interest space of the user is then generated at 806 based on the allocated channels. At 808, the interest engine can store the personal interest space associated with the user. The process then moves on to 830 to update content of a channel based on a request or a timer. In one embodiment, the process also includes 820 to 824. The user's dynamic information is obtained at 820. Then at 822, the interest engine can determine whether to update the personal interest space of the user based on the dynamic information. If it is determined not to update the personal interest space at 823, the process goes back to 820. Otherwise, if it is determined to update the personal interest space at 823, the process go on to 824, where the personal interest space is updated based on the dynamic information. The process may then go to 830 to update content of a channel based on a request or a timer.

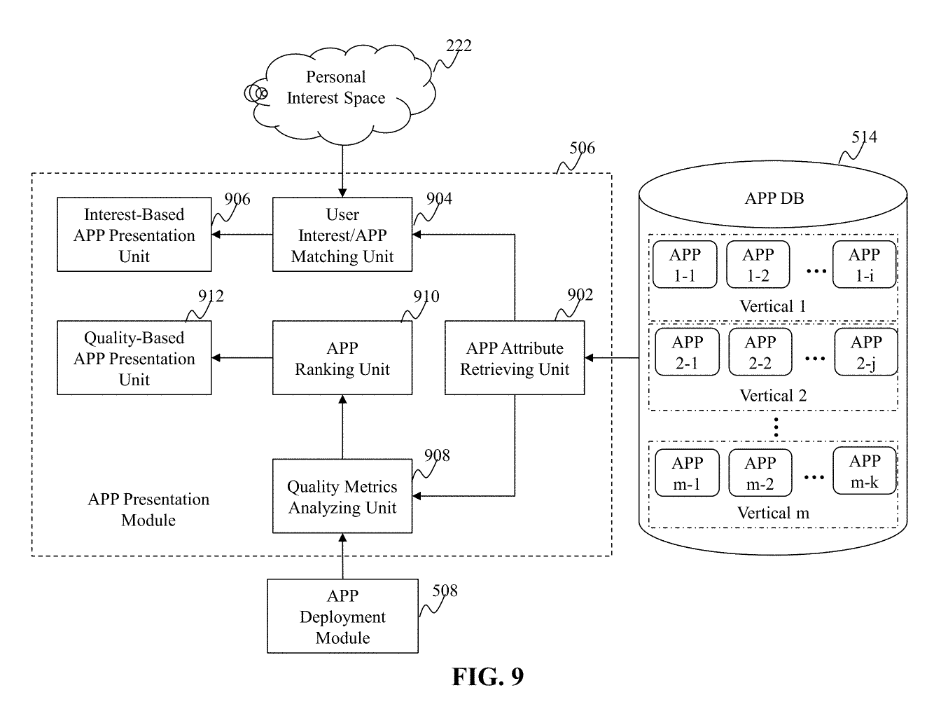

FIG. 9 illustrates an exemplary diagram of an application presentation module, according to an embodiment of the present teaching. The application presentation module 506 in this example includes an application attribute retrieving unit 902, a user interest/application matching unit 904, an interest-based application presentation unit 906, a quality metrics statistics analyzing unit 908, an application ranking unit 910, and a quality-based application presentation unit 912. In this embodiment, apps available in the app eco-space 200 are stored in the application database 514 and organized in verticals (categories). Each vertical may include a plurality of apps. In addition to vertical, each app may be associated with other attributes, such as name, version, last updated date/time, developer, purchase price, size, etc.

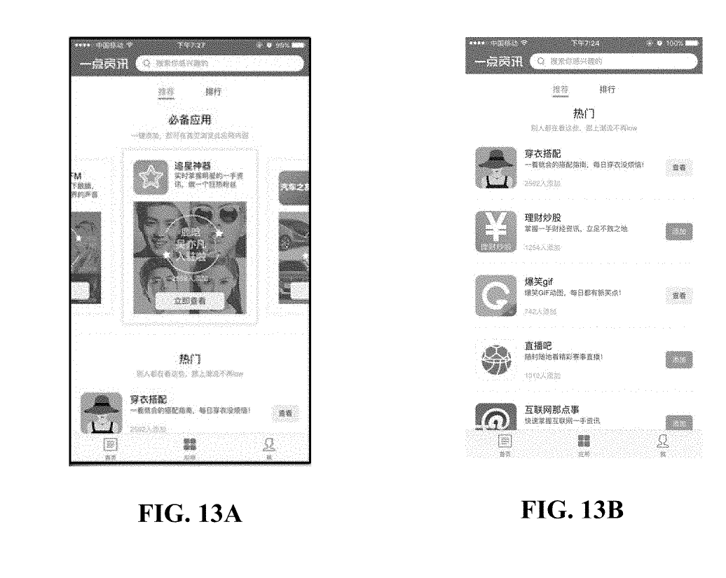

The application attribute retrieving unit 902 in this example retrieves relevant attributes from each app stored in the application database 514. In one embodiment, the vertical (category) attributes may be retrieved and provided to the user interest/application matching unit 904. The user interest/application matching unit 904 matches each of the user's interests from the personal interest space 222 with one or more apps based on their verticals. The matched apps are provided to the personalized application presentation unit 906 and presented to the user 102. As shown in FIG. 13A, in an exemplary interface of a super app “Particle News,” an app named “Groupie” is recommended to a user who is interested in pop stars. The user then can easily install the app by clicking the download icon.

Back to FIG. 9, in another embodiment, other attributes related to an app's quality, e.g., name, version, last updated date/time, developer, purchase price, and size, are retrieved by the application attribute retrieving unit 902 and provided to quality metrics analyzing unit 908. The quality metrics analyzing unit 908 may further collect information related to the apps' qualities from other sources, e.g., the application deployment module 508. For example, the quality metrics analyzing unit 908 may calculate the number of installations among different users for each app or the amount of usage of each app by the same or different uses. For each quality metric, the quality metrics analyzing unit 908 generates a score for each app based on the received attributes and any other information. The quality metric includes, for example, popularity, recency, user rating, etc. Based on the scores of each app, the application ranking unit 910 ranks the apps, for example, in each vertical or all together. The quality-based application presentation unit 912 presents the apps based on their rankings. As sown in FIG. 13B, in an exemplary interface of the super app “Particle News,” the most popular apps among general user population, e.g., “Fashion,” “Investment,” “Funny GIF,” “Live Sports,” and “Anything about the Internet,” are recommended to the user. The user then can easily install any of these popular apps by clicking the respective download icon.

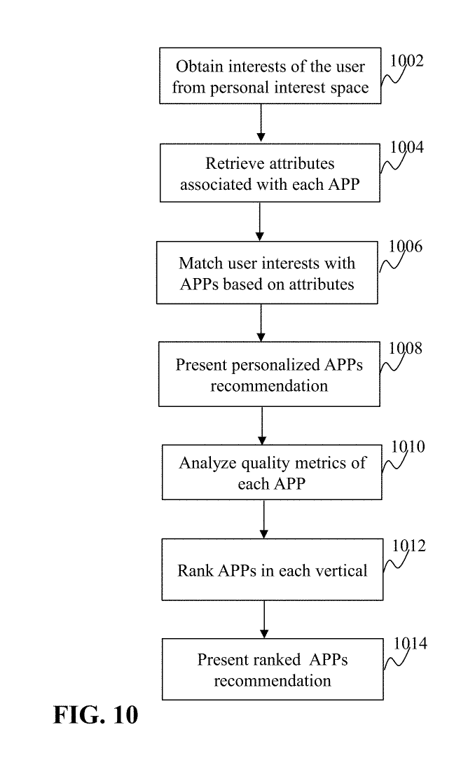

FIG. 10 is a flowchart of an exemplary process performed by the application presentation module, according to an embodiment of the present teaching. Starting at 1002, interests of the user are obtained from the personal interest space. At 1004, attributes associated with each app available in the app eco-space are retrieved. The attributes include, for example, vertical (category), name, version, last updated date/time, developer, purchase price, size, etc. At 1006, user interests are matched with apps based on their attributes, e.g., verticals. At 1008, the matched personalized apps are recommended to the user. At 1010, quality metrics of each app are analyzed, such as popularity, recency, user rating, etc. At 1012, apps in each vertical are ranked. In some embodiments, apps from different verticals are ranked all together. The ranking may be based on the one or more quality metrics. At 1014, the ranked apps are recommended to the user.

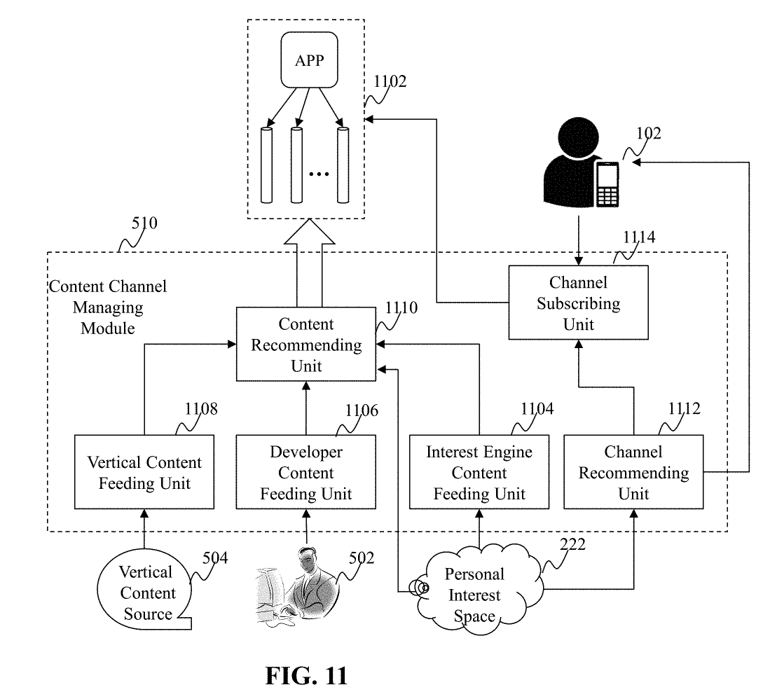

FIG. 11 illustrates an exemplary diagram of a content channel managing module, according to an embodiment of the present teaching. For each deployed app 1102, the content channel managing module 510 facilitates the user 102 to subscribe content channels and provides a content stream. The main content stream of the deployed app 1102 may be further organized into sub-content streams for each content channel. In this example, the content channel managing module 510 includes an interest engine content feeding unit 1104, a developer content feeding unit 1106, a vertical content feeding unit 1108, a content recommending unit 1110, a channel recommending unit 1112, and a channel subscribing unit 1114.

In this embodiment, the channel recommending unit 1112 and the channel subscribing unit 1114 facilitate the user 102 to subscribe one or more channels within the deployed app 1102. The channel recommending unit 1112 may obtain the user 102's interests from the personal interest space 222 and recommend content channels related to the user 102's interest. The channel recommending unit 1112 may also recommend channels based on their quality metrics, such as popularity of each channel. In receiving the recommended channels, the user 102 may select and subscribe to any of them via the channel subscribing unit 1114. In some embodiments, via the channel subscribing unit 1114, the user 102 may search for and subscribe to other channels that have not been recommended to the user 102.

In this embodiment, the interest engine content feeding unit 1104 may fetch content from the personal interest space 222. As mentioned above, the personal interest space 222 may include updated content in each content channel subscribed to by the user 102. For example, the app eco-space 200 may be implemented as a news app in which news content is provided to the user 102 from different channels subscribed to by the user 102, e.g., sports news, political news, etc. For a third-party app 1102 deployed within the app eco-space 200, the third-party app 1102 may fetch news content from the personal interest space 222 created and updated by the app eco-space 200 and include the fetched news content in its content stream.

The developer content feeding unit 1106 in this example obtains content from the developer 502 of the third-party app 1102. For example, the developer 502 may be a radio station, and the third-party app 1102 may be a radio app. The radio station may continuously feed radio programs and related content to the user 102 via the radio app. In another example, the developer 502 may be a curator who regularly publishes articles, and the app 1102 may be a platform by which the curator provides the articles to the user 102. The vertical content feeding unit 1108 in this example obtains content from the corresponding vertical content source 504. For example, the app 1102 may be a car review app, and the vertical content feeding unit 1108 may periodically retrieve the most recent car review articles from cars.com, Edmunds.com, and kbb.com.

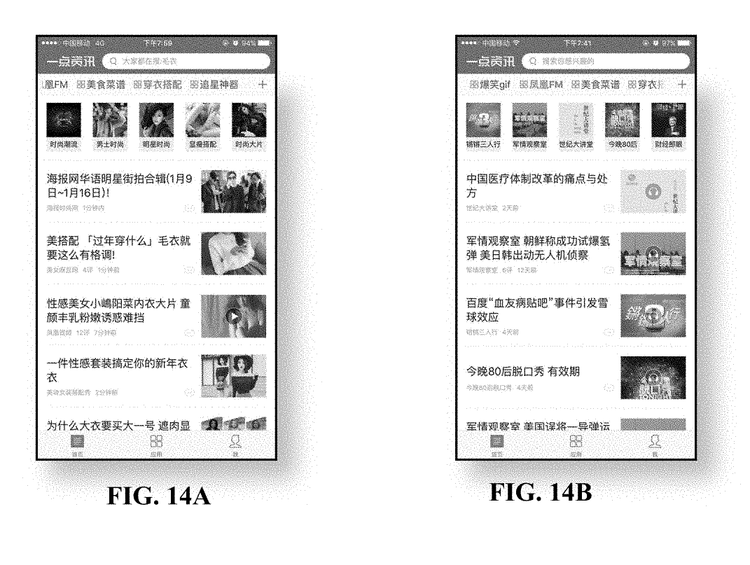

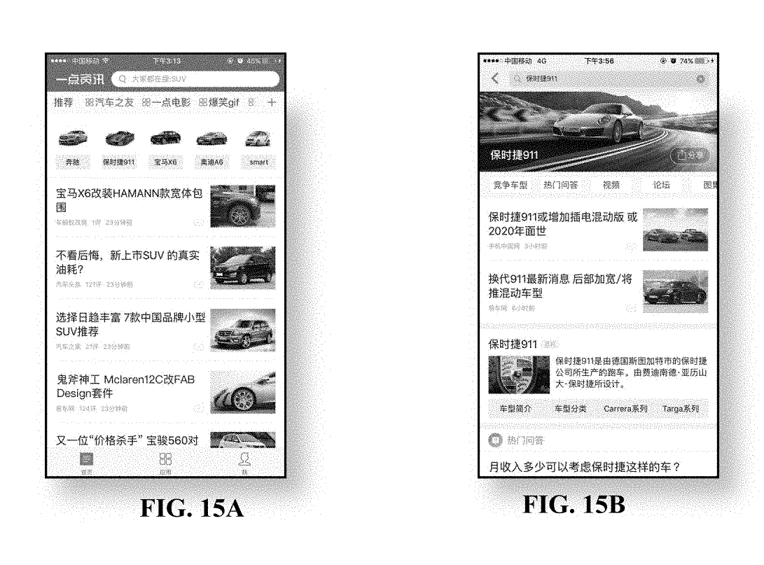

Additionally or optionally, the content recommending unit 1110 may filter and/or rank content from different sources based on the user 102's interests from the personal interest space 222. The content recommending unit 1110 may also remove duplicated content from different sources and organize the content based on the content channels of the app 1102. As shown in FIG. 14A, in an exemplary interface of the super app “Particle News,” four tabs corresponding to four deployed apps “Phoenix Radio Station,” “Food Recipes,” “Fashion,” and “Groupie” are provided on top of the screen. The app “Fashion” is activated in this example, and a list of content channels subscribed to by the user is provided, including for example, “fashion trend,” “Men's fashion,” etc. Without selecting a specific channel, articles from each of the subscribed channels are provided together in the main display area of the interface. Similarly, in FIG. 14B, the app “Phoenix Radio Station” is activated, and a list of content channels (radio programs in this example) is provided. In the main display area of the interface, the most recent episodes of each radio program are provided before the user selects a particular radio program. In FIG. 15A, another app “Car Review” is activated, and a list of content channels subscribed to by the user is provide (e.g., Benz, Porsche 911, BMW X6, Audi A6, Smart). Without selecting a specific channel, articles from each of the subscribed channels are provided together in the main display area of the interface. In FIG. 15B, once the Porsche 911 channel is selected, articles related to Porsche 911 are displayed in the main display area of the interface. Additional sub-channels under the Porsche 911 channel may be further selected, such as similar models, FAQ, videos, forum, etc.

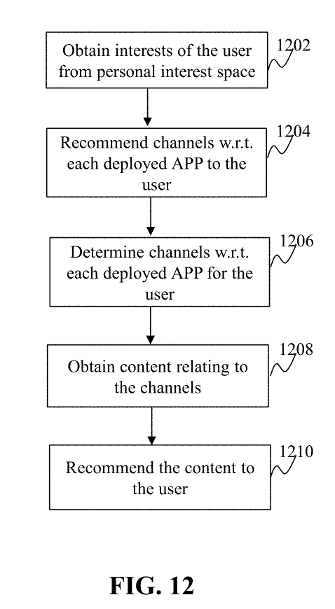

FIG. 12 is a flowchart of an exemplary process performed by the content channel managing module, according to an embodiment of the present teaching. Starting at 1202, interests of the user are obtained from the personal interest space. At 1204, one or more channels with respect to each of the deployed apps are recommended to the user. In one example, at least one of the channels is recommended based on the user's interests. In another example, at least one of the channels is recommended based on one or more quality metrics, such as popularity. At 1206, one or more channels with respect to each of the deployed apps are determined for the user. In one example, at least one of the channels is selected by the user from the recommended channels. In another example, the user can search and subscribe to any other channel that has not been recommended. At 1208, content relating to the subscribed channels is obtained. The content may be obtained from any source, such as a third-party vertical content source, the developer who created the deployed app, and the user's personal interest space. At 1210, the obtained content is recommended to the user via the subscribed channels of the deployed app in the app eco-space.

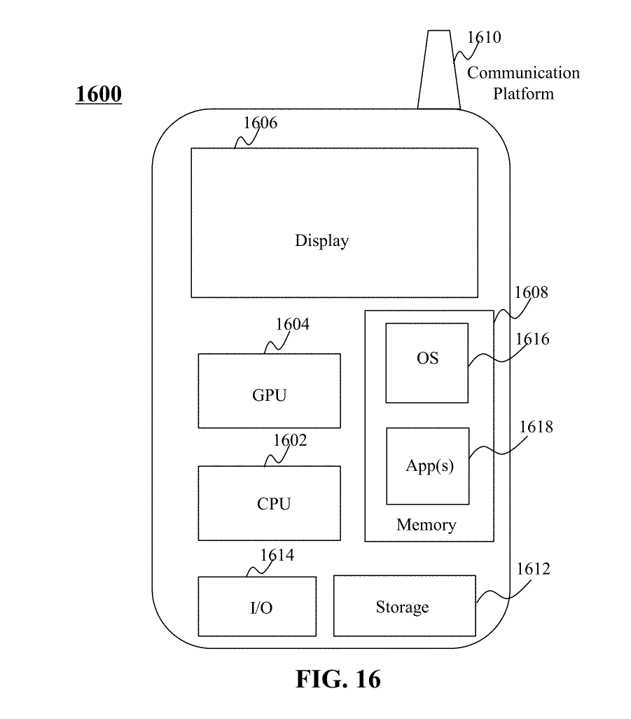

FIG. 16 depicts the architecture of a mobile device which can be used to realize a specialized system implementing the present teaching. In this example, a device of the user 102 used may be a mobile device 1600, including, but not limited to, a smart phone, a tablet, a music player, a handheld gaming console, a global positioning system (GPS) receiver, and a wearable computing device (e.g., eyeglasses, wrist watch, etc.), or in any other form. The mobile device 1600 in this example includes one or more central processing units (CPUs) 1602, one or more graphic processing units (GPUs) 1604, a display 1606, a memory 1608, a communication platform 1610, such as a wireless communication module, storage 1612, and one or more input/output (I/O) devices 1614. Any other suitable component, such as but not limited to a system bus or a controller (not shown), may also be included in the mobile device 1600. As shown in FIG. 16, a mobile operating system 1616, e.g., iOS, Android, Windows Phone, etc., and one or more applications 1618 may be loaded into the memory 1608 from the storage 1612 in order to be executed by the CPU 1602. The applications 1618 may include any suitable mobile apps as mentioned above. Execution of the applications 1618 may cause the mobile device 1600 to perform some processing as described in the present teaching. For example, user inputs may be received via the I/O devices 1614 and sent to the user interest engine 220 via the communication platform 1610. Presentation of the recommended content to the user 102 may be made by the GPU 1604 in conjunction with the display 1606.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

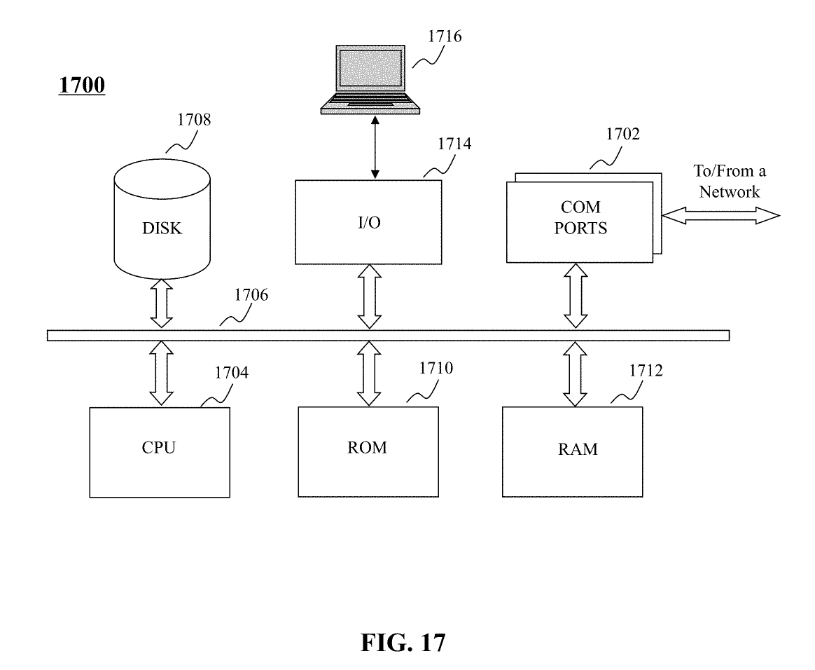

FIG. 17 depicts the architecture of a computing device which can be used to realize a specialized system implementing the present teaching. The computer may be a general-purpose computer or a special purpose computer. This computer 1700 can be used to implement any components of the multi-level content platform as described herein. Different components of the system, e.g., as depicted in FIG. 5, can all be implemented on one or more computers such as computer 1700, via its hardware, software program, firmware, or a combination thereof. Although only one such computer is shown, for convenience, the computer functions relating to multi-level content platform may be implemented in a distributed fashion on a number of similar platforms, to distribute the processing load.

The computer 1700, for example, includes COM ports 1702 connected to and from a network connected thereto to facilitate data communications. The computer 1700 also includes a CPU 1704, in the form of one or more processors, for executing program instructions. The exemplary computer platform includes an internal communication bus 1706, program storage and data storage of different forms, e.g., disk 1708, read only memory (ROM) 1710, or random access memory (RAM) 1712, for various data files to be processed and/or communicated by the computer, as well as possibly program instructions to be executed by the CPU 1704. The computer 1700 also includes an I/O component 1714, supporting input/output flows between the computer and other components therein such as user interface elements 1716. The computer 1700 may also receive programming and data via network communications.

Hence, aspects of the method of multi-level content platform, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the personal interest space exploration system and its components as disclosed herein can be implemented as a firmware, firmware/software combination, firmware/hardware combination, or a hardware/firmware/software combination.

While the foregoing has described what are considered to constitute the present teachings and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine, each of which has at least one processor, storage, and a communication platform connected to a network for deploying applications, comprising the steps of:
presenting an interface corresponding to an application eco-space to a user, wherein the application eco-space comprises one or more applications;
obtaining first information associated with the user via the interface, wherein the first information characterizes interest of the user;
identifying at least one of the one or more applications to be recommended to the user based on the first information; and
deploying the at least one of the one or more applications within the application eco-space in a manner consistent with the interest of the user based on the first information.

2. The method of claim 1, wherein the deploying comprises:
determining, with respect to each of at least some of the deployed at least one application, one or more channels of content based on second information associated with the user; and
recommending, to the user, content relating to the one or more channels associated with each of the at least some of the deployed at least one application to the user in the application eco-space.

3. The method of claim 2, wherein
the first information specifies the at least one of the one or more applications; or
the second information specifies the one or more channels of content for each of the at least some of the deployed at least one application.

4. The method of claim 2, further comprising:
updating the application eco-space based on third information associated with the user, wherein the application eco-space is updated with respect to at least one of the one or more applications or at least one of the one or more channels of content associated with any one of the deployed applications.

5. The method of claim 2, wherein
each of the one or more applications is associated with a vertical content domain; and
the content associated with the application is in the vertical content domain.

6. The method of claim 1, wherein at least one of the one or more applications is created by a third-party developer.

7. The method of claim 1, wherein the deploying comprises:
generating a tab for each of the deployed at least one application on a same page of the interface so that the user can switch between the deployed at least one application via the tabs.

8. The method of claim 1, wherein the deploying comprises:
creating a link for each of the deployed at least one application on a desktop of an operating system in which the an application eco-space is deployed so that the user can access the deployed at least one application in the application eco-space via the links.

9. The method of claim 1, wherein each of the one or more applications has a same look-and-feel.

10. A system for deploying applications, comprising:
a user interest engine configured for obtaining first information associated with a user, wherein the first information characterizes interest of the user;
a presentation module configured for presenting an interface corresponding to an application eco-space to the user, wherein the application eco-space comprises one or more applications, and configured for identifying at least one of the one or more applications to be recommended to the user based on the first information; and
a deployment module configured for deploying the at least one of the one or more applications within the application eco-space in a manner consistent with the interest of the user based on the first information.

11. The system of claim 10, further comprising:
a content channel managing module configured for determining, with respect to each of at least some of the deployed at least one application, one or more channels of content based on second information associated with the user, and recommending, to the user, content relating to the one or more channels associated with each of the at least some of the deployed at least one application to the user in the application eco-space.

12. The system of claim 11, wherein
the first information specifies the at least one of the one or more applications; or
the second information specifies the one or more channels of content for each of the at least some of the deployed at least one application.

13. The system of claim 11, further comprising:
a updating module configured for updating the application eco-space based on third information associated with the user, wherein the application eco-space is updated with respect to at least one of the one or more applications or at least one of the one or more channels of content associated with any one of the deployed applications.

14. The system of claim 11, wherein
each of the one or more applications is associated with a vertical content domain; and
the content associated with the application is in the vertical content domain.

15. The system of claim 10, wherein at least one of the one or more applications is created by a third-party developer.

16. The system of claim 10, wherein the deployment module is further configured for generating a tab for each of the deployed at least one application on a same page of the interface so that the user can switch between the deployed at least one application via the tabs.

17. The system of claim 10, wherein the deployment module is further configured for creating a link for each of the deployed at least one application on a desktop of an operating system in which the application eco-space is deployed so that the user can access the deployed at least one application in the application eco-space via the links.

18. The system of claim 10, wherein each of the one or more applications has a same look-and-feel.

19. A non-transitory machine-readable medium having information recorded thereon for deploying applications, wherein the information, when read by the machine, causes the machine to perform the following:
presenting an interface corresponding to an application eco-space to a user, wherein the application eco-space comprises one or more applications;
obtaining first information associated with the user via the interface, wherein the first information characterizes interest of the user;
identifying at least one of the one or more applications to be recommended to the user based on the first information; and
deploying the at least one of the one or more applications within the application eco-space in a manner consistent with the interest of the user based on the first information.

20. The medium of claim 19, wherein the deploying comprises:
determining, with respect to each of at least some of the deployed at least one application, one or more channels of content based on second information associated with the user; and
recommending, to the user, content relating to the one or more channels associated with each of the at least some of the deployed at least one application to the user in the application eco-space.

21. The medium of claim 20, wherein
the first information specifies the at least one of the one or more applications; or
the second information specifies the one or more channels of content for each of the at least some of the deployed at least one application.

22. The medium of claim 20, further comprising:
updating the application eco-space based on third information associated with the user, wherein the application eco-space is updated with respect to at least one of the one or more applications or at least one of the one or more channels of content associated with any one of the deployed applications.

23. The medium of claim 20, wherein
each of the one or more applications is associated with a vertical content domain; and
the content associated with the application is in the vertical content domain.

24. The medium of claim 19, wherein at least one of the one or more applications is created by a third-party developer.

25. The medium of claim 19, wherein the deploying comprises:
generating a tab for each of the deployed at least one application on a same page of the interface so that the user can switch between the deployed at least one application via the tabs.

26. The medium of claim 19, wherein the deploying comprises:
creating a link for each of the deployed at least one application on a desktop of an operating system in which the application eco-system is deployed so that the user can access the deployed at least one application in the application eco-space via the links.

27. The medium of claim 19, wherein each of the one or more applications has a same look-and-feel.
